(19) United States
(12) Patent Application Publication
(10) Pub. No.: US 2023/0357471 A1
(43) Pub. Date: Nov. 9, 2023

(54) HIGH MOLECULAR WEIGHT ACRYLIC PROCESSING AID CONCENTRATE FOR THERMOPLASTIC PROCESSING

(71) Applicant: Rohm and Haas Company, Collegeville, PA (US)

(72) Inventors: John E. Cornetta, East Pikehand Twp, PA (US); Ian J. Drake, Conshohocken, PA (US); Richard J. Ketz, Norristown, PA (US); Hailan Guo, Warrington, PA (US); Theodore P. Price, Collegeville, PA (US)

(73) Assignee: Rohm and Haas Company, Collegeville, PA (US)

(21) Appl. No.: 18/026,137

(22) PCT Filed: Sep. 24, 2021
(86) PCT No.: PCT/US2021/051848

§ 371 Date: Mar. 14, 2023

Related U.S. Application Data
(60) Provisional application No. 63/085,489, filed on Sep. 30, 2020.

(51) Int. Cl. C08F 220/14; C08F 210/02; B29C 48/00; C08L 51/00; C08L 27/14; B29C 48/395; C08F 220/18

(52) U.S. Cl. CPC C08F 220/14; B29C 48/022; B29C 48/397; C08F 210/02; C08F 220/1802; C08F 220/1804; C08F 220/1808; C08L 27/14; C08L 51/003; B29K 2027/06; C08L 2205/025; C08L 2205/03; C08L 2207/20

(57) ABSTRACT

Disclosed is a composition comprising a polyolefin polymer and a core-shell acrylic polymer comprising a high molecular weight processing aid and a carrier resin. The high molecular weight processing aid is present in an amount ranging from 30% to less than 100% by weight relative to the total weight of the high molecular weight processing aid and the carrier resin, and the carrier resin is present in an amount ranging from greater than 0% to 70% by weight relative to the total weight of the high molecular weight processing aid and the carrier resin. The composition is in the form of particles having an average particle size of at least 2 mm.

### FIELD OF THE INVENTION

The field of this invention is high molecular weight acrylic processing aid concentrates.

### BACKGROUND

Polyvinyl chloride (PVC) is widely used on a variety of applications, including building and constructions products, such as fencing, siding, decking, trim boards, fascia boards, window frames, sills, and doors. PVC polymer virgin resin is generally supplied in powder form. The PVC is typically formulated by dry blending with other components, which are also in powder form, and thermally processed by melt extrusion into the finished product.

Acrylic processing aids are commonly one of the powdered components incorporated into the PVC formulation. Acrylic processing aids are typically added in parts per hundred resin (phr) to the PVC.

Environmental sustainability is driving interest in reusing and recycling materials, including PVC, to increase the amount of post-consumer or post-industrial waste in the material stream. When incorporated into PVC formulations, post-consumer or post-industrial scrap PVC is typically mixed with virgin PVC powder. However, problems arise with the use of scrap PVC.

Recycled PVC is pulverized from already formed parts. The pulverized PVC particles are typically much larger than the virgin PVC powder. The difference in particle size presents problems when mixing prior to extrusion. These problems may include particle separation and non-uniform mixing of the composition.

Another problem when using scrap PVC arises due to the fact that many PVC formulations already contain added components from the original formulation. Because these added components are not removed during the pulverization process, the scrap PVC particles will have a different composition than the virgin PVC powder.

The present invention seeks to solve one or more of the problems identified above.

### SUMMARY OF THE INVENTION

Disclosed herein is a composition comprising a polyolefin polymer and a core-shell acrylic polymer comprising a high molecular weight processing aid and a carrier resin, wherein the high molecular weight processing aid is present in an amount ranging from 30% to less than 100% by weight relative to the total weight of the high molecular weight processing aid and the carrier resin, and the carrier resin is present in an amount ranging from greater than 0% to 70% by weight relative to the total weight of the high molecular weight processing aid and the carrier resin, and wherein the composition is in the form of particles having an average particle size of at least 2 mm.

Also disclosed herein is a polyvinyl chloride composition comprising a polyvinyl chloride resin and a composition comprising a polyolefin polymer and a core-shell acrylic polymer comprising a high molecular weight processing aid and a carrier resin, wherein the high molecular weight processing aid is present in an amount ranging from 30% to less than 100% by weight relative to the total weight of the high molecular weight processing aid and the carrier resin, and the carrier resin is present in an amount ranging from greater than 0% to 70% by weight relative to the total weight of the high molecular weight processing aid and the carrier resin, and wherein the composition is in the form of particles having an average particle size of at least 2 mm

A method of preparing the polyvinyl chloride composition and an article made therefrom are also disclosed.

### DETAILED DESCRIPTION OF THE INVENTION

Disclosed herein is an improved processing aid for use in polyvinyl chloride compositions. The processing aid of the present invention is a composition comprising a high molecular weight processing aid and a carrier resin, wherein the composition is in the form of particles having an average particle size of at least 2 mm.

As used herein, “high molecular weight processing aid” is a processing aid having a weight average molecular weight of at least 500,000 g/mol. Preferably, the high molecular weight processing aid has a weight average molecular weight of at least 5,000,000 g/mol. More preferably, the high molecular weight processing aid has a weight average molecular weight of at least 10,000,000 g/mol.

As used herein, “average particle size” is the arithmetic mean of all possible diameters. The aspect ratio of the particles is the ratio of the longest to the shortest diameters. The particles may have any shape, including for example, spherical, cylindrical, oblong, cuboid, prismatic, or irregular.

Suitable high molecular weight polymer processing aids useful in the present invention include polymers and copolymers containing vinyl aromatic, (meth)acrylonitrile, and alkyl (meth)acrylate monomers. As used herein, “(meth)acrylonitrile” includes both methacrylonitrile and acrylonitrile monomers. Similarly, “alkyl (meth)acrylate” includes both alkyl methacrylate and alkyl acrylate monomers.

Preferably, the high molecular weight processing aid is a copolymer comprising alkyl (meth)acrylate monomers. For example, the high molecular weight processing aid is a copolymer comprising methyl (meth)acrylate. The methyl (meth)acrylate copolymer may comprise, for example, monomers selected from other alkyl (meth)acrylate monomers, such as ethyl acrylate, butyl acrylate, and 2-ethyl hexyl acrylate. An exemplary high molecular weight processing aid comprises copolymers containing a majority (i.e., at least 50% by weight relative to the total weight of the high molecular weight processing aid) of methyl methacrylate (“MMA”) and a minority (i.e., less than 50% by weight relative to the total weight of the high molecular weight processing aid) of alkyl acrylates, such as ethyl acrylate, butyl acrylate, or 2-ethyl hexyl acrylate.

The high molecular weight processing aid may comprise core-shell-type processing aids that combine an external lubricant functionality with that of processing aid functionality. These “lubricating-processing aids” provide the typical processing-performance properties of acrylic processing aids, but have the added advantage of an external-lubricant function, which improves flow and machine running time by significantly reducing sticking of the molten polyvinyl chloride resin to hot metal surfaces of the processing equipment.

Commercially available high molecular weight processing aids are available from The Dow Chemical Company, Midland, Michigan, under the tradenames PARALOID™ and SURECEL™. One preferred high molecular weight processing aid is SURECEL™ 21607-XP,

The carrier resin may be a passive component in the composition. Alternatively, the carrier resin may also be active as a processing aid. Examples of passive carrier resins include, but are not limited to, immiscible polymers such as polyethylene, polyethylene terephthalate, polypropylene, and inorganic materials such as talc, calcium carbonate, and fibers. Examples of active carrier resins include, but are not limited to, terpolymers such as ethylene terpolymers, polyvinyl chloride blends, and polyethylene waxes.

One preferred class of carrier resins includes terpolymers, such as ethylene terpolymers. For example, the carrier resin may comprise an ethylene/n-butyl acrylate/carbon monoxide terpolymer, such as ELVALOY™ HP661 available from The Dow Chemical Company.

The high molecular weight processing aid is preferably present in an amount ranging from 30% to less than 100% by weight relative to the total weight of the high molecular weight processing aid and the carrier resin. For example, the high molecular weight processing aid can be present in an amount of at least 40%, at least 50%, at least 60%, 65%, at least 70%, at least 75%, at least 80%, at least 85%, at least 90%, or at least 95% by weight relative to the total weight of the high molecular weight processing aid and the carrier resin. The high molecular weight processing aid can be present in an amount less than 95%, less than 90%, less than 85%, less than 80%, less than 70%, less than 60%, or less than 50% by weight relative to the total weight of the high molecular weight processing aid and the carrier resin.

The carrier resin is preferably present in an amount ranging from greater than 0% to 70% by weight relative to the total weight of the high molecular weight processing aid and the carrier resin. For example, the carrier resin can be present in the composition in an amount greater than 5%, greater than 10%, greater than 15%, greater than 20%, greater than 30%, greater than 40%, or greater than 50% by weight relative to the total weight of the high molecular weight processing aid. The carrier resin may be present in an amount less than 60%, less than 50%, less than 40%, less than 35%, less than 30%, less than 25%, less than 20%, less than 15%, less than 10%, or less than 5% by weight relative to the total weight of the high molecular weight processing aid and the carrier resin.

The composition of the present invention is present in the form of particles having an average particle size of at least No. 10 mesh or 2 mm. For example, the particles may have an average particle size of at least No. 8 mesh, at least No. 6 mesh, or at least No. 5 mesh. When used with a finely pulverized resin, the average particle size of the composition may be smaller than No. 10 mesh.

The composition may further comprise additional components, including lubricants, heat stabilizers, antioxidants, fillers, coloring agents, and other additives. When present, these additives may be present in an amount ranging from greater than 0% to 50% by weight relative to the total weight of the high molecular weight processing aid, the carrier resin, and the additive, such as, for example, from greater than 0% to 40%, from 1% to 35%, from 2% to 30%, or from 5% to 25% by weight relative to the total weight of the high molecular weight processing aid, the carrier resin, and the additive.

Suitable lubricants that may be used in the composition include internal and external lubricants, as well as lubricants that have a balance between internal and external lubricating properties. Generally, external lubricants determine the behavior of hot plastic compounds at interfaces with other materials such as delaying fusion/gelation and reducing sticking and friction, and internal lubricants influence rheological processes inside the polymer phase such as providing lubrication between the polymer chains and improving melt flow. Examples of lubricants include, for example, esters such as monoglycerin esters, hydrocarbon waxes such as paraffin wax, polyethylene wax, and oxidized polyethylene wax, esters, stearyl alcohol, fatty acids such as stearic acid, fatty-acid amides such as ethylene bis-stearamide (i.e., two C16-C18 alkyl groups covalently bonded to a central polar amide group), soaps, and stearate salts such as calcium stearate. Suitable external lubricants include, but are not limited to, long chain montan acid (i.e., a long chain C28-C32 alkyl group covalently bonded to a polar group, such as carboxylic acid), paraffins and hydrocarbons having short branched chain alkyl groups, n-paraffins having long straight chain hydrocarbons, polyethylene waxes having very long straight hydrocarbon chains with a few branches. Suitable lubricants that provide a balance between internal and external lubrication include synthetic fatty acid partially saponified with calcium and long-chain montan ester types (e.g., Wax OP, and Wax E available from American Hoechst Corp., Mountainside, N.J.). Further information on lubricants for PVC can be found in a review by McMurrer, M. C., Ed. “Update: Lubricants for PVC”, Plastics Compounding, pp. 74.-90 July/August 1982.

Suitable antioxidants include, but are not limited to, phenolic antioxidants, phosphate antioxidants, sulfur antioxidants, and blends thereof. Exemplary antioxidants include those sold by Adeka under the ADK STAB brand.

Examples of suitable heat stabilizers for the composition include, but are not limited to organotin stabilizers (e.g., MARK® organotin heat stabilizers from Galata Chemicals), mixed metal heat stabilizers (e.g., MARK® liquid and solid mixed metal heat stabilizers from Galata Chemicals), and phosphite stabilizers (e.g., MARKPHOS® phosphite heat stabilizers from Galata Chemicals).

The particles of the present invention may be prepared, for example, by blending the components as a powder and thermally processed in an extruder or compressed/consolidated o form the particles. Because high heat or high shear may degrade the molecular weight of the processing aid, it is preferred that processes for producing the particles minimize the temperature and/or shear extrusion or compression.

A polyvinyl chloride (PVC) composition can be prepared by blending a polyvinyl chloride resin with the particles of the composition comprising the high molecular weight processing aid and the carrier resin. The composition comprising the high molecular weight processing aid and the carrier resin may be present in the PVC composition in an amount ranging from, for example, 0.5 to 20 parts per hundred resin (phr). For example, the composition comprising the high molecular weight processing aid and the carrier resin may be present in the PVC composition in an amount ranging from, for example, 1 to 15 phr or from 2 to 10 phr.

Preferably, the polyvinyl chloride resin comprises recycled PVC. As used herein, “recycled PVC” refers to post-consumer or post-industrial scrap, i.e., non-virgin PVC. Typically, recycled PVC is processed by pulverizing articles made of polyvinyl chloride. The pulverization process produces particles of polyvinyl chloride having an average particle size ranging from, for example, 2 mm to 20 mm. Preferably, the PVC composition comprises at least 25% by weight recycled PVC based on the total weight of the polyvinyl chloride resin. More preferably, the PVC composition comprises at least 40%, at least 50%, at least 60%, at least 70%, or at least 80% by weight recycled PVC based on the total weight of the polyvinyl chloride resin.

The polyvinyl chloride resin may also comprise virgin polyvinyl chloride resin, which may be present as a powder. When present, the virgin polyvinyl chloride resin is preferably present in a mixture with recycled polyvinyl chloride resin. The mixture of polyvinyl chloride resin may comprise both powder and particles of polyvinyl chloride resin. When such mixtures are used, a mixture of powdered processing aids and the particles of the composition comprising the high molecular weight processing aid and carrier resin may be used. Alternatively, the processing aid may be solely provided by the particles of the composition comprising the high molecular weight processing aid and the carrier resin.

Preferably, the particles of the composition comprising the high molecular weight processing aid and the carrier resin have an average size that is at least 10% of the average size of the polyvinyl chloride resin particles. More preferably, the particles of the composition comprising the high molecular weight processing aid and the carrier resin have an average size that is at least 20% of the average size of the polyvinyl chloride resin particles. For example, when the average particle size of the polyvinyl chloride resin is 20 mm, the average particle size of the particles comprising the high molecular weight processing aid and the carrier resin is at least 2 mm.

The present invention also relates to articles made from polyvinyl chloride resin compositions having the particles comprising the high molecular weight processing aid and carrier resin according to embodiments described above.

Another aspect of the present invention relates to a method of preparing a polyvinyl chloride composition comprising blending a polyvinyl chloride resin with particles of the composition comprising the high molecular weight processing aid and carrier resin. The particles of the composition comprising the high molecular weight processing aid and carrier resin can be incorporated at high concentrations which is let down into the bulk polyvinyl chloride resin during an extrusion process.

### EXAMPLES

Particles of a composition comprising a high molecular weight processing aid, SURECEL™ 21607-XP (The Dow Chemical Company), and a carrier resin, ELVALOY™ HP661 were prepared. The high molecular weight processing aid and carrier resin were blended at weight percentages of 75% and 25%, respectively. Particles were made using either a ¾ in. (1.9 cm) low compression single-screw extruder with water trough and a pelletizer, or using a continuous mixer system with a Banbury® mixer with single screw attached and a die face underwater cutter.

Gel permeation chromatograph (GPC) was used to determine the molecular weight of the high molecular weight processing aid. The GPC data is shown below in Table 1.

TABLE 1

| Sample (SURECEL™ 21607XP/ ELVALOY™ HP661, 75/25 blend) | Abs. MW | | PS-relative MW | | %Rec (%) |
|---|---|---|---|---|---|
| | Mw (kDa) | Mn (kDa) | Mw (kDa) | Mn (kDa) | |
| Example 1 | 16707 | 8745 | 17868 | 5186 | 86.6 |
| Example 2 | 11971 | 6074 | 13238 | 3716 | 95.3 |
| Example 3 | 12633 | 6591 | 13878 | 3978 | 93.3 |
| Example 4 | 12532 | 5452 | 13842 | 3394 | 98.6 |
| Example 5 | 12253 | 6384 | 13455 | 4000 | 94.6 |
| Example 6 | 12718 | 5125 | 14346 | 3272 | 93.0 |
| Example 7 | 13178 | 3944 | 15009 | 2813 | 90.2 |

What is claimed is:

1. A composition comprising:
a high molecular weight processing aid; and
a carrier resin;
wherein the high molecular weight processing aid is present in an amount ranging from 30% to less than 100% by weight relative to the total weight of the high molecular weight processing aid and the carrier resin, and the carrier resin is present in an amount ranging from greater than 0% to 70% by weight relative to the total weight of the high molecular weight processing aid and the carrier resin; and
wherein the composition is in the form of particles having an average particle size of at least 2 mm.

2. The composition of claim 1 wherein the high molecular weight processing aid is a polymer or copolymer comprising monomers selected from vinyl aromatic, (meth)acrylonitrile, and alkyl (meth)acrylate monomers.

3. The composition of claim 1 or 2 wherein the high molecular weight processing aid is a copolymer comprising alkyl (meth)acrylate monomers.

4. The composition of claim 3 wherein the high molecular weight processing aid is a copolymer comprising methyl methacrylate and at least one monomer selected from alkyl acrylate monomers.

5. The composition of claim 4 wherein the alkyl acrylate monomers are selected from ethyl acrylate, butyl acrylate, or 2-ethyl hexyl acrylate.

6. The composition of any of the preceding claims wherein the high molecular weight processing aid has a weight average molecular weight of at least 5,000,000 g/mol.

7. The composition of any of the preceding claims wherein the high molecular weight processing aid has a weight average molecular weight of at least 10,000,000 g/mol.

8. The composition of any of the preceding claims wherein the carrier resin is selected from an ethylene terpolymer.

9. The composition of claim 9 wherein the carrier resin is an ethylene/n-butyl acrylate/carbon monoxide terpolymer.

10. A polyvinyl chloride composition comprising a polyvinyl chloride resin and the composition according to any of the preceding claims.

11. The polyvinyl chloride composition according to claim 10 wherein the polyvinyl chloride resin comprises recycled polyvinyl chloride resin.

12. The polyvinyl chloride composition according to claim 11 wherein the polyvinyl chloride resin comprises a blend of recycled polyvinyl chloride resin and virgin polyvinyl chloride resin.

13. An article formed from the composition according to any one of claims 10 to 12.

14. A method of preparing a polyvinyl chloride composition comprising blending a polyvinyl chloride resin and the composition according to any one of claims 1 to 9.
